(19) United States
(12) Patent Application Publication
(10) Pub. No.: US 2015/0358822 A1
(43) Pub. Date: Dec. 10, 2015

(54) Utilizations and Applications of Near Field Communications in Mobile Device Management and Security

(71) Applicants: Michael Thomas HENDRICK, (US); Mark REED, (US); Dan SHCAFFNER, (US); Philip ATTFIELD, (US); Julia NARVAEZ, (US); Paul CHENARD, (US); SEQUITUR LABS, INC., Issaquah, WA (US)

(72) Inventors: Michael Thomas HENDRICK, Renton, WA (US); Mark REED, Redmond, WA (US); Dan SCHAFFNER, Seattle, WA (US); Philip ATTFIELD, Fall City, WA (US); Julia NARVAEZ, Tacoma, WA (US); Paul CHENARD, Corvallis, OR (US)

(21) Appl. No.: 14/655,148

(22) PCT Filed: Dec. 27, 2013
(86) PCT No.: PCT/US13/78004

§ 371 Date: Jun. 24, 2015

Related U.S. Application Data
(63) Continuation of application No. 13/945,677, filed on Jul. 18, 2013.
Application No. 13/945,677 is a continuation of application No. 14/062,849, filed on Oct. 24, 2013.
(60) Provisional application No. 61/746,533, filed on Dec. 27, 2012.

(51) Int. Cl. H04W 12/08; G06F 21/82; G06F 21/62

(52) U.S. Cl. CPC H04W 12/08; G06F 21/629; G06F 21/82

(57) ABSTRACT

Systems and methods for using Near Field Communications¹ (NFC) m\d other short-range wireless communications technologies in mobile device management and security. Uses of NFC devices of both passive and active types are presented herein, as “policy control points” (PCPs) within a policy-based system for mobile handset management, in situations where granular control of handset capabilities is required. Certain location-based, as well as non-location-specific variants of the invention are presented as examples.

### PRIORITY CLAIM

This application claims priority to U.S. provisional application 61/746,533 filed on Dec. 27, 2012. In addition, this application is a continuation-impart of U.S. application Ser. No. 14/062,849 filed on Oct. 24, 2013, which claims benefit to U.S. provisional application 61/718,660, filed on Oct. 25, 2012. This application is also a continuation-in-part of U.S. application Ser. No. 13/945,677 filed on Jul. 18, 2013, which claims benefit to US provisional application 61/673,220, filed on Jul. 18, 2012. This application incorporates the disclosures of all applications mentioned in this paragraph by reference as if Lilly set forth herein.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### BACKGROUND OF THE INVENTION

Short-range wireless communications technologies and related standards such as Near Field Communications (NFC)¹, RFID², and Bluetooth³ have grown in popularity and usage in recent years, in part due to the growing popularity of “smartphones”, tablet computers, and other mobile computing and communications devices. The advent and growing prevalence of short range wireless technologies on mobile handsets and other communications and computing devices are leading to new opportunities for utilizing these technologies in ways that can make particular use of their short range, for example for security applications in which longer range signal interception would be undesirable, and for specialized marketing opportunities that can be coupled with confirmed device presence at a location or near a specific asset or item.

Certain early-proposed uses of short-range wireless communications such as NFC fall within the general subject area of access control, The use of a pair of wireless communications units for controlling access to a physical area closed by a door, and utilizing a transmitted access code, and with one wireless unit having a range of less than ten meters, is presented in U.S. Pat. No. 7,796,012. Another personnel access control system involving mobile wireless devices, and based on pairs of NFC devices, is presented in US patent publication 2012/0220216. The use of NFC to remotely modify access credentials, and to control access to certain assets, within a secure access system, is presented in U.S. Pat. No. 8,150,374. In U.S. Pat. No. 8,127,337, a system incorporating short-range wireless communications and transmission and use of biometric templates is presented, in Which one or more privacy policies regarding permissible dissemination of the information in the biometric template are associated with the communications.

In the present application, we disclose certain novel uses of short-range wireless communications such as NFC in regard to management of specific capabilities and functions of mobile devices. Our application considers and presents uses of both passive NFC elements (“tags”), and active NFC devices, in both location-based and non-location-based situations.

### BRIEF DESCRIPTION OF THE DRAWINGS

FIG. 1 is a schematic representation of a policy-based access control and management system for mobile handsets.

FIG. 2 is a schematic representation of a use of passive NFC tags for handset management associated with presence in a meeting room, theater, locker room, factory floor, secured facility, or other premises where individuals may come and go, within a policy-based system.

FIG. 3 is a schematic representation of a use of active NFC devices for handset management associated with presence in a meeting room or similar premises, within a policy-based system.

FIG. 4 is a schematic representation of use of passive, writable NFC tags plus tag polling for handset management associated with presence in a meeting room or similar premises, within a policy-based system. Tag_{C} represents a passive NFC tag located near the room entrance.

FIG. 5 is a schematic representation of use of multiple NFC tags for handset management for the case of a simple layered building perimeter and meeting room scenario.

FIG. 6 is a flowchart representing use of NFC tags to invoke policy decisions for device management.

### DETAILED DESCRIPTION OF THE INVENTION

The following describes preferred embodiments. However, the invention is not limited to those embodiments. The description that follows is for purpose of illustration and not limitation. Other systems, methods, features and advantages will be or will become apparent to one skilled in the art upon examination of the figures and detailed description. It is intended that all such additional systems, methods, features, and advantages be included within this description, be within the scope of the inventive subject matter, and be protected by the accompanying claims.

Aspects of the invention, including attestation and related concepts, can be implemented and utilized to both facilitate and augment such policy-based access control and management systems and methods, including ways in which attestation can be beneficially utilized in mobile computing security and mobile handset management.

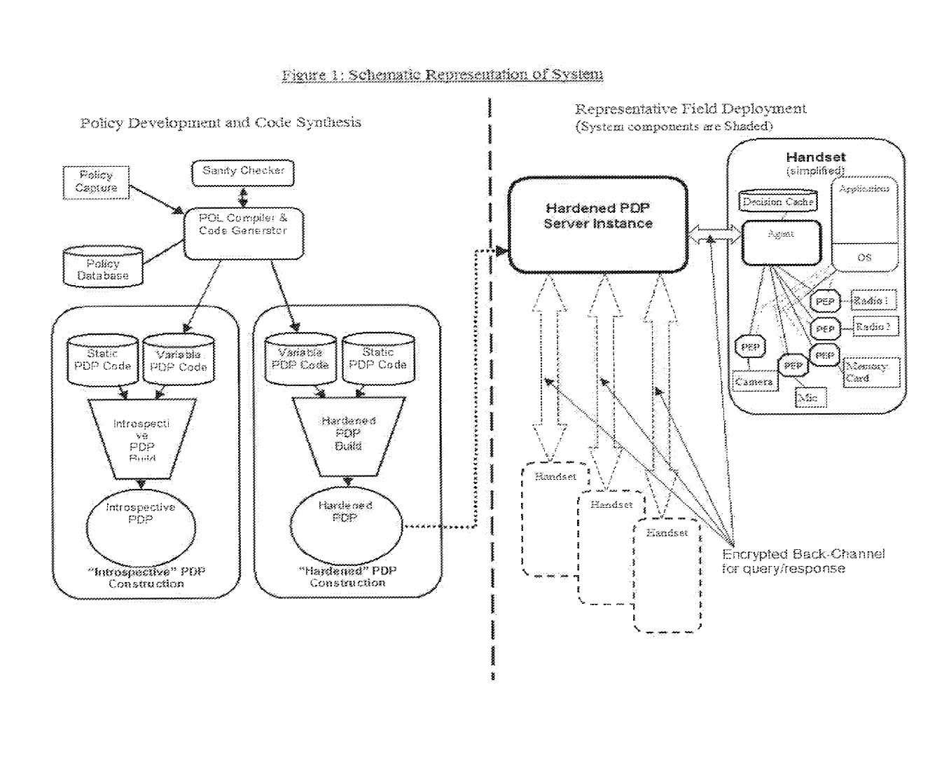

U.S. patent application Ser. No. 13/945,677 discloses a system for policy-based access control and management for mobile computing devices, the disclosure of which is incorporated as if fully set forth herein, Such a system is summarized in FIG. 1. Particularly notable in such a system in the present context is the granularity of control that it allows in regard to permitted operations, plus network, file system, and device access on handsets controlled by the system. Furthermore, the system utilizes one or more Policy Decision Point (PDP) servers which respond to encrypted queries from handsets controlled by a given instance of the system. These PDP servers may be remote from the handset, or may even be hosted within the handset. The queries typically encapsulate requests for use of specific handset or network-accessible assets, and the PDP response to such a request is then received by the querying handset, with subsequent decisions made by the PDP then enforced by Policy Enforcement Points (PEPs) on the handset.

Short-range wireless technologies such as NFC can be beneficially utilized to complement and augment such a policy-based access control and management system.

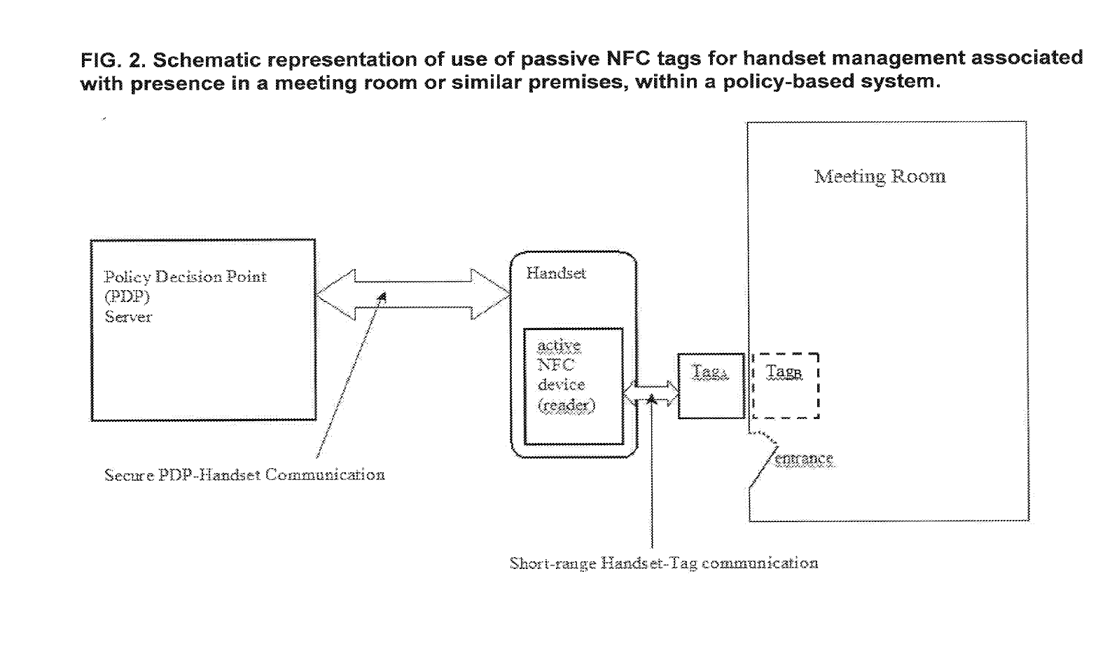

In the embodiment represented in FIG. 2, a user about to enter premises such as a conference room or meeting room. In this case, prior to entering the room, the user swipes or otherwise presents his mobile device such as a phone handset, containing active NFC capabilities near a specific passive NFC tag located at the entrance to the room or nearby such an entrance. Note that While NFC is presented in the depicted embodiment, other technologies may be used. For example, embodiments encompass phone handsets containing electronics having capabilities equivalent to active NFC, or those having access to such capabilities through connected modules or by other means (such as plug-in cards or peripheral devices connected to the mobile device by USB or other connection technologies, or by wireless technologies such as Bluetooth or by wired networking). All such embodiments are contemplated by the invention. In FIG. 2, the passive tag is denoted “Tag_{A}”. Upon reading of Tag_{A}, the handset presents a tag identifier such as an ID number, read from the Tag_{A}, to the PDP via a query, with the result that relevant policies held within the PDP are examined and the resultant PDP decision may limit, disable, enable, or otherwise modify certain handset capabilities. For example, the policies may specify that handset functions and capabilities such as one or more cameras, microphones, speakers, and ring tones be disabled when the handset is in the room, or, alternatively, is in certain proximity to the NFC tag, and so the tag recognition triggers policy invocation that ultimately results in said capabilities on the handset being effected, limited, or even shut down entirely after the handset has detected the tag. Such proximity may be determined, for example, by radio frequency signal strengths or transmission delay times, with or without use of triangulation, or by any other distance determining methods or position-determining methods. Later, at the end of the meeting or otherwise upon exiting the meeting room, the handset user may wish to restore access to prior device capabilities that may have been disabled. Such restoration may be triggered or requested by swiping the handset a second time past the same NFC tag, or alternately, past a second tag (denoted Tag_{B} in the depicted embodiment), the second tag being specifically an “exit tag” in this case. In other embodiments, the state of a handset in the system may be serialized either remotely on the handset as a “session”, with the session state being preserved or destroyed based on room presence as detected by the NFC swiping or by other means, such as a time-limited session duration, or by user or administrator intervention. In alternate embodiments, for the first case of just one tag, a user interface may be presented to the user or to a third party, upon reading of the tag, wherein said user interface provides an In/Out selection for the handset status relative to the room of interest, with the selection then resulting in appropriate policy-driven response. In these above situations, the NFC tag(s), while passive, effectively act as Policy Control Points (PCPs). In regard to capabilities that have been disabled as described above, policies may also provide an automatic restoration of the previously disabled capabilities, as non-limiting examples, after some time period such as the expected duration of a conference meeting session, or upon some distance or position change such as leaving the conference room as described above.

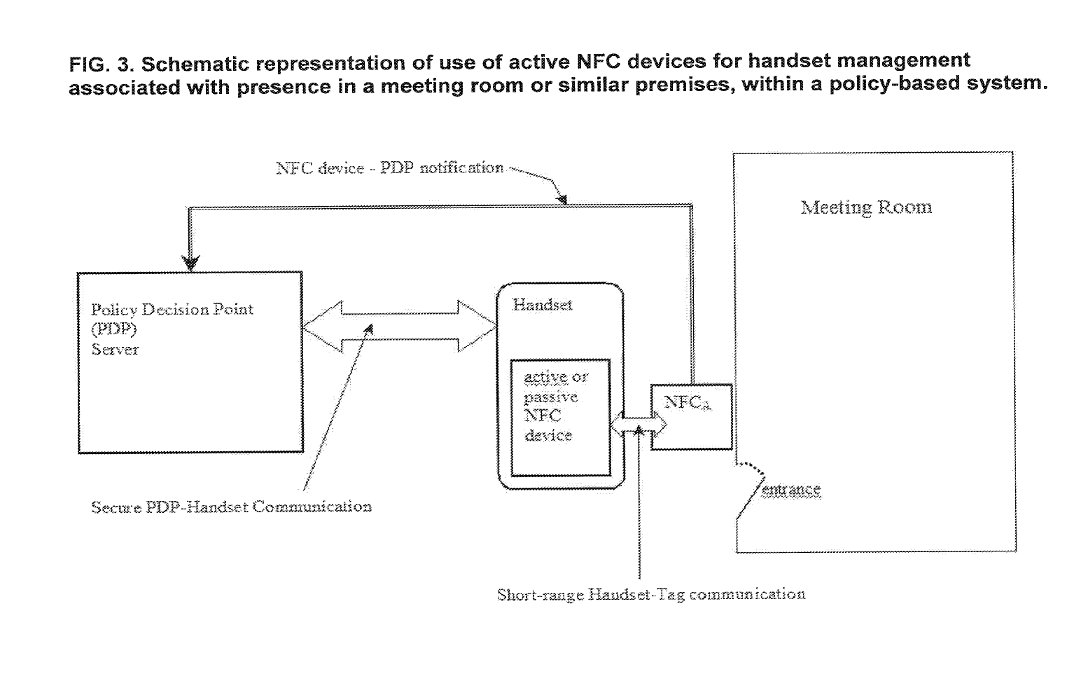

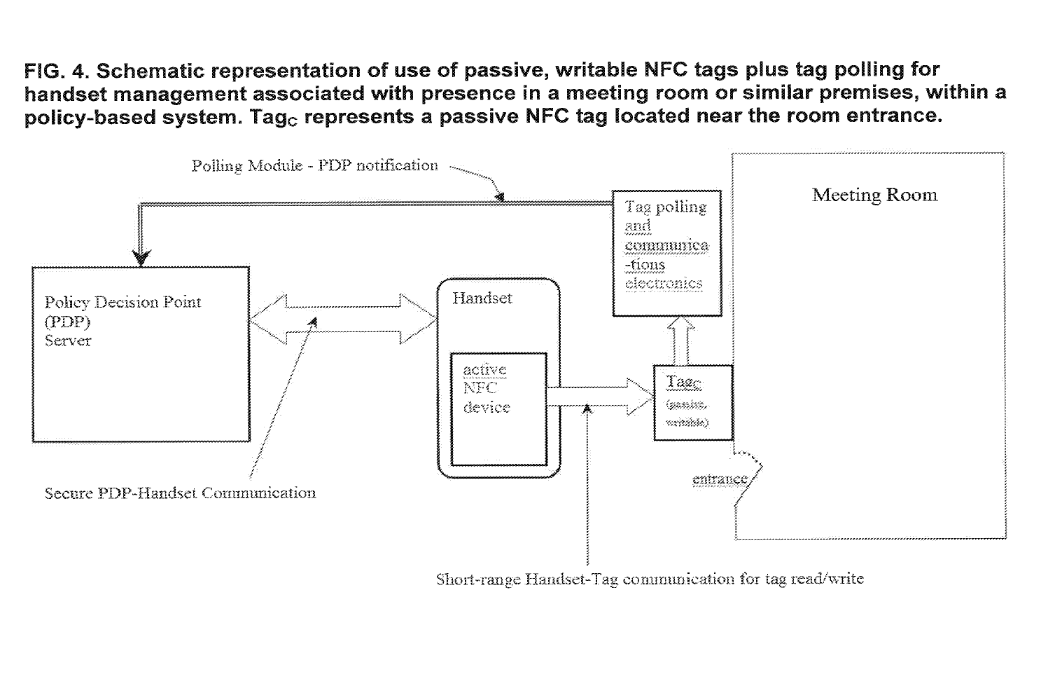

Additional embodiments include active NFC devices rather than passive NFC tags. FIG. 3 presents certain such possibilities. In embodiment depicted in FIG. 3, prior to entering the room, the user swipes or otherwise presents their mobile device such as a phone handset, containing either active or passive NFC capabilities or functionally equivalent electronics, near a specific active NFC device and other associated electronics, represented here as NFC_{A}, located at the entrance to the room or nearby such an entrance. (Again, other embodiments may include equivalent technologies and capabilities, as discussed above.) NFC_{A} then reads identifying information from the handset and communicates this to the PDP through secure means such as encrypted transmission over a wireless channel, such that relevant policies held within the PDP are examined and the resultant PDP decision may limit, disable, or otherwise modify certain handset capabilities. For example, the policies may specify that handset functions and capabilities such as one or more cameras, microphones, speakers, and ring tones be disabled when the handset is in the room, and so the NFC interaction as described triggers policy invocation that ultimately results in said capabilities being shutdown after the active NFC device has detected the presence of the handset. Near-equivalent function may also be implemented as shown in the embodiment depicted in FIG. 4, by substituting a passive, writable NFC tag, Tag_{C}, in place of NFC_{A}. In one embodiment, additional electronics are used for frequent polling of Tag_{C} to detect interactions with inbound handsets. The polling case requires additional electronic components for performing the polling, but reduces the amount of handset-PDP communication required. A disadvantage of the polling case, however, compared to that using the prior active NFC tag, is that the additional communication channel between the polling module and the PDP or the handset, said channel then representing a potential area of vulnerability to security risks despite the use of encrypted communications. An alternate embodiment may obviate the use of direct NFC_{A}-PDP communication by relaying NFC_{A} data via the handset to the PDP. Similar to the embodiment depicted in FIG. 2, restoration of earlier capabilities may be triggered or requested by presentation of the handset to a second NFC device, that being an “exit” device, or in another embodiment, by a second presentation of the handset to NFC_{A}. In a yet further embodiment, meeting attendees may register their handsets with a meeting authority prior to the meeting (or the handsets may otherwise be known to the system, with appropriate software installed as per the handset shown in FIG. 1) and then be provided with distinct badges containing NFC tags. These badges may then be presented to active NFC devices located at the entrance to a meeting room or nearby such an entrance, and similarly trigger policy-driven responses from PDPs, resulting in capability modifications on the registered handsets. This variant does riot require NFC capabilities on the handset In a further embodiment, registration of a handset may occur prior to a meeting, whereby a handset's NFC identifier is known at the time of registration.

In a further embodiment, the handset may be used as a “badge” to access a protected facility in which taking pictures is not allowed. In this manner, a person such as an employee can use the handset as a badge when arriving and leaving. During the time that person is at the facility, the PDP responses ensure that the handset complies with the security policies specific for the protected facility or room within the facility. In one embodiment, such a facility would be a health club where a policy might disallow camera in the locker room. In another embodiment, a school may wish to disallow phone capabilities such as texting in an examination room, or a movie theater may wish to disable audible phone capabilities and alerts, except for emergency calls, in theaters during movie presentations, and possibly also to limit phone screen brightness in the theater during movie presentations. These are just examples. Further embodiments are contemplated by the invention, and will immediately become apparent to a person of ordinary skill in the art.

For any embodiment with active or passive NFC devices presented above, specialized reporting functions are contemplated by the invention for presenting the accumulated handset data, for example, relating to a venue such as a meeting room. In one embodiment, a report may contain data such as the total number of handsets N that are currently present in the room, based upon swipes at the NFC reader at the entrance into the meeting room. N may then be compared with other counts of meeting room attendees such as from a show of hands or other method, or with the expected number of conference attendees, for purposes such as data validation, or as a security measure to detect unauthorized attendees, or to gauge conference participation levels by comparison with expected attendance levels.

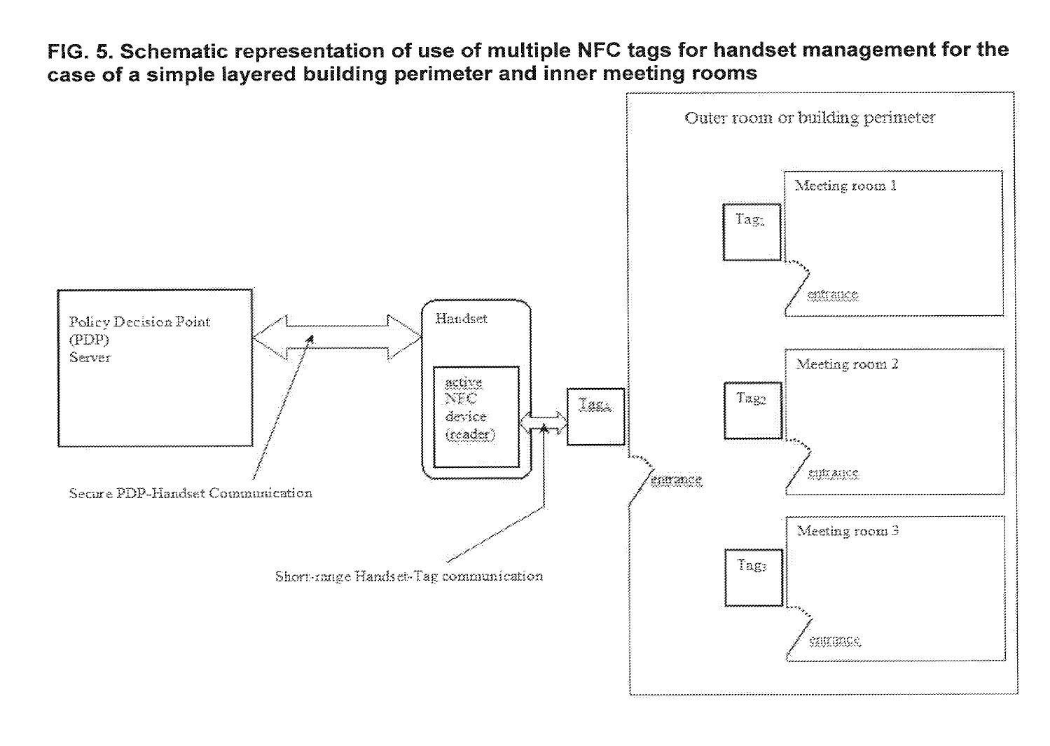

Also contemplated are embodiments for use with multiple meeting rooms within a given venue, such as a conference with parallel meeting sessions in separate rooms. In such an embodiment, a distinct NFC reader would be provided for each room. A hierarchy of deployments of “layered” access controls is also contemplated, for cases such as overall building or conference access control with subsequent access control to rooms within the building or conference. One simple example of such a layered embodiment is represented in FIG. 5.

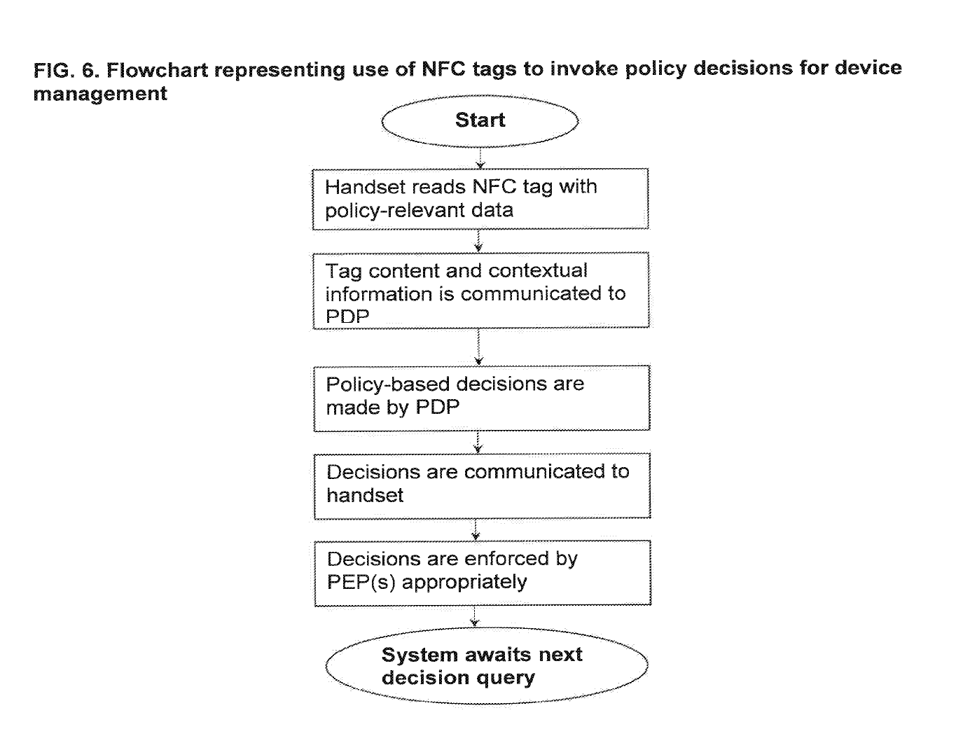

Apart from the location-specific situations such as those involving meeting rooms presented above, other embodiments represent useful and convenient ways to manage and control sets of handset capabilities through policy invocation involving NFC tags used as PCPs. For example, as given tag with a unique identifier may simply be coupled with a specific policy or set of policies on the PDP that are then caused to be examined by the PDP when the tag is read or “consumed” by a handset, without necessarily any reference to a room or other location. In this manner, such a tag is in essence a token representing and triggering specific sets of policies to be active. A simplified representation of this is provided in flowchart form in FIG. 6. There may be a set of tags, each representing certain distinct policies or distinct policy sets. In one embodiment, having a collection of such tags represents as convenient means of switching between various sets of device capabilities. This is useful in embodiments where handset administration is performed by various parties. For example, a network administrator may utilize such tokens for configuration of multiple handsets, where handsets are made to read a token prior to being activated in the network, and appropriate network access policies are then applied for the handset. In another embodiment, a parent or guardian may maintain a set of NFC tags as tokens for invoking specific policies and policy sets restricting activity on phones belonging to children in their custody. In addition, a given user may have a collection of multiple tags for convenient, rapid invocation of specific policy sets corresponding to each tag. In each of these example embodiments, the tags may or may not be in a writable state by specific parties, as appropriate to the application. For example, a parent may have write access to modify policies whereas the child and handset user may not. Other embodiments may require that tags are present near the handset for certain policy sets to be active. Such embodiments will be easily identified by those skilled in the art, and are within the scope of the invention.

As another example of the aforementioned embodiments, an enterprise may enable a visitor's handset to temporarily comply with the enterprise's security policies. To have the enablement happen, the visitor may go to the enterprise's security officer who scans the handset and checks it in. From that point, the handset follows the enterprise's security policies regardless of the visitor's specific location, until the handset is checked out. In further embodiments, additional potential capability enablement on presentation of the handset to an NFC tag at an entry point of a secured facility could include the activation, of video chat software or other application software on the handset to enable communication and further authentication with security personnel or systems. In such embodiments, security personnel or an automated system could provide further instructions to the handset user, conduct a live verification or authentication, with successful verification or authentication then resulting in triggering of door opening, local wireless network access, and to enablement of other capabilities or access to services.

In certain embodiments, policy authoring and query processing for our system, as well as device capability control and policy enforcement, may typically be controlled by a 3rd party such as a network carrier or other communications service provider. This presents certain business opportunities for such a service provider, which are contemplated by the invention. In one embodiment, the service provider may offer to manage and provide policy-based control of handsets to an enterprise or other entity, for a fee such as a subscription fee or per-service fee, or per-handset fee. In another embodiment, a communications carrier may provide blockage of handset camera usage to a business customer such as a health club, as a service offering for a fee. These are but a few embodiments that will immediately become apparent to a person of ordinary skill.

While many embodiments described herein refers to wireless technologies collectively known as Near Field Communications (NFC), the invention contemplates that other wireless as well as wired communications and locating technologies may be substituted for NFC. Such technologies include but are not restricted to geo-location technologies such as the Global Positioning System (GPS), or visibility or proximity of a beacon, cell tower, or similar device, as well as use of network adapter and network adapter Media Address Control (MAC) address and Internet Protocol (IP) address, or combination of these technologies. Furthermore, while the term “handset” and similar terms are used throughout this disclosure, it is used as a representative term for brevity reasons. The invention contemplates substitution of any computing device with appropriate communication capabilities for a typical handset, such as any phone, tablet, or other computing device with the requisite capabilities.

### REFERENCES

1. NFC Forum (2007), “Near Field Communication and the NFC. Forum: The Keys to Truly Interoperable Communications” (PDF), http://www.nfc-forum.org, retrieved Oct. 30, 2012

2. Landt, Jerry (2001), “Shrouds of Time: The history of RFID”, AIM, Inc, pp 5-7

3. Bluetooth Special Interest Group website, “A Look at the Basics of Bluetooth Wireless Technology”, http:www.bluetooth.com/Pages/Basics.aspx, retrieved Oct. 29, 2012

1. A system for managing one or more capabilities of mobile computing devices comprising:
a. a client mobile computing device having a reader for reading data from a passive near field communications (NFC) tag;
b. a server configured to:
i. accept a query from the mobile computing device, wherein the query comprises data from a passive NFC tag;
ii. calculate from the query one or more policy-based decisions for permitting, limiting, or restricting use of one or more of the capabilities of the mobile computing device;
iii. transmit the policy-based decisions to the mobile computing device.

2. The system of claim 1, wherein the mobile computing device further comprises a camera, and the capabilities comprise functions for accessing or using the camera.

3. The system of claim 1, wherein the mobile computing device further comprises one of an audio input device and an audio output device, and the capabilities comprise functions for accessing or using one of the audio input device and the audio output device.

4. The system of claim 3, wherein the audio input device comprises one of a microphone and an input audio jack.

5. The system of claim 3, wherein the audio output device comprises one of a speaker and an output audio jack.

6. The system of claim 1, wherein the mobile computing device further comprises a means for conducting a telephone call or other audio or video communications, and the capabilities comprise functions for conducting the telephone call or accessing or using the other audio or video communications

7. The system of claim 1, wherein the mobile computing device further comprises a messaging means such as SMS texting or e-mail, and the capabilities comprise functions for accessing or using the messaging means.

8. The system of claim 1, wherein the mobile computing device further comprises a computer network interface, and the capabilities comprise functions for accessing or using the computer network interface.

9. The system of claim 8, wherein the functions for accessing or using the network interface further comprise functions for enabling or disabling a network connection based on one of a network address associated with the network connection, a port number associated with the network connection, a network protocol associated with the network connection, data transmitted in association with the network connection, or data received in association with the network connection.

10. The system of claim 1, wherein the capabilities comprise execution or other operation of executable software

11. The system of claim 1, wherein the passive NFC tag is disposed near an entrance of a room, and wherein the server is configured to calculate a policy decision for a query comprising data from the passive NFC tag.

12. The system of claim 11, wherein a second passive NFC tag is disposed near a second entrance of a second room, and wherein the server is configured to calculate a second policy decision for a query comprising data from the second passive NFC tag.

13. The system of claim 1, wherein the query received by the server is stored in a memory for retrieval and analysis.

14. The system of claim 1, wherein data from the passive NFC tag is stored in memory on the mobile computing device.

15. The system of claim 13, wherein the retrieval and analysis further comprises creating and displaying a report showing room occupancy over time.

16. The system of claim 1, wherein the server is operated by a third party.

17. The system of claim 1, wherein the server is operated by a third party for a fee.

18. A system for managing one or more capabilities of mobile computing devices comprising:
a. an active NFC device disposed near an entrance of a room for reading data from a badge or mobile computing device presented to the NFC device;
b. a server configured to:
i. accept a notification from the active NFC device, wherein the notification comprises data from the badge or mobile computing device;
ii. calculate from the notification one or more policy-based decisions for permitting, limiting, or restricting use of one or more of the capabilities of the mobile computing device;
iii. transmit the policy-based decisions to the mobile computing device.

19. The system of claim 18, wherein the mobile computing device further comprises a camera, and the capabilities comprise functions for accessing or using the camera.

20. The system of claim 18, wherein the mobile computing device further comprises one of an audio input device and an audio output device, and the capabilities comprise functions for accessing or using one of the audio input device and the audio output device.

21. The system of claim 20, wherein the audio input device comprises one of a microphone and an input audio jack.

22. The system of claim 20, wherein the audio output device comprises one of a speaker and an output audio jack.

23. The system of claim 18, wherein the mobile computing device further comprises a means for conducting a telephone call or other audio or video communications, and the capabilities comprise functions for conducting the telephone call or accessing or using the other audio or video communications.

24. The system of claim 18, wherein the mobile computing device further comprises a messaging means such as SMS texting or e-mail, and the capabilities comprise functions for accessing or using the messaging means.

25. The system of claim 18, wherein the mobile computing device further comprises a computer network interface, and the capabilities comprise functions for accessing or using the computer network interface.

26. The system of claim 25, wherein the functions for accessing or using the network interface further comprise functions for enabling or disabling a network connection based on one of a network address associated with the network connection, a port number associated with the network connection, a network protocol associated with the network connection, data transmitted in association with the network connection, or data received in association with the network connection.

27. The system of claim 18, wherein the capabilities comprise execution or other operation of executable software

28. The system of claim 18, wherein a second active NFC tag is disposed near a second entrance of a second room, and wherein the server is configured to calculate a second policy decision for a second notification comprising data read from the badge or mobile computing device by the second active NFC tag.

29. The system of claim 18, wherein the notification received by the server is stored in a memory for retrieval and analysis.

30. The system of claim 18, wherein the retrieval and analysis further comprises creating and displaying a report showing room occupancy over time.

31. The system of claim 18, wherein the server is operated by a third party.

32. The system of claim 31, wherein the server is operated by the third party for a fee

33. A method for managing one or more capabilities of mobile computing devices comprising:
a. reading data from a passive near field communications (NFC) tag;
b. calculating from the data one or more policy-based decisions for permitting, limiting, or restricting use of one or more capabilities of a mobile computing device; and
c. transmitting the policy-based decisions to the mobile computing device.
